(19) United States
(12) Patent Application Publication
(10) Pub. No.: US 2023/0263145 A1
(43) Pub. Date: Aug. 24, 2023

(54) FISHING LURE LINE ATTACHMENT SYSTEM

(71) Applicant: William Fox, New Richmond, OH (US)

(72) Inventor: William Fox, New Richmond, OH (US)

(21) Appl. No.: 18/309,821

(22) Filed: Apr. 30, 2023

Related U.S. Application Data
(63) Continuation-in-part of application No. 17/400,690, filed on Aug. 12, 2021.

(51) Int. Cl. A01K 85/00

(52) U.S. Cl. CPC A01K 85/1851; A01K 85/022

(57) ABSTRACT

The present invention discloses a fishing lure. The fishing lure comprises a head having an aperture. The aperture is configured to receive a fishing line therethrough. The fishing lure further comprises a body structure having a channel to enable passage of the fishing line from the head through a longitudinal axis of the body structure and extend beyond the body structure. The head is configured to lock with the body structure while locking the fishline therein. The fishing lure further comprises a flexible weed guard mounted over the body.

### CROSS-REFERENCE TO RELATED APPLICATIONS

The present Application is a continuation-in-part of U.S. patent application Ser. No. 17/400,690 entitled “FISHING LURE LINE ATTACHMENT SYSTEM”, filed Aug. 12, 2021, which is hereby expressly incorporated by reference herein for all purposes.

### TECHNICAL FIELD

The present disclosure relates generally to a fishing lure, and more particularly, to a fishing lure with a fishing line attachment for providing a user with the ability to attach the fishing line relatively easily and quickly to the lure without having to tie a knot, and without additional or intermediate structures.

### BACKGROUND

Fishing is a worldwide recreational and sustenance activity, with professional and amateur competitions quite common. Many anglers prefer to use artificial lures versus live bait. A lure is generally any type of artificial fishing bait which is designed to attract a fish's attention. Consequently, countless artificial bait lures and attachments have been developed to attract and catch fish, and numerous lures and attachments have been adapted to mimic the appearance and movement of common fish prey.

All these attachments are required to connect to a fishing line, which is in turn connected to a fishing pole used for casting and retrieving the lure and fish. One conventional method of connecting fishing line to a fishing lure for example, involves utilization of one or more intermediate connectors. One method of connecting lures involves providing a lure body with an eyelet. The free end of the fishing line is passed through the eyelet and a knot is manually tied using a variety of fishing knots, some of which are very complicated, time consuming and inefficient, and especially so if an angler is aging, young, inexperienced, has poor dexterity or diminished eyesight, and especially in low light conditions or during unstable situations that are typical when fishing, kayaking, and boating.

During fish retrieval, it is common for fishing line to break or come untied at the point of attachment to the lure, thereby losing the fish. So, it is further desirable to have an attachment means that is capable of reliably holding the fighting fish without losing it due to those reasons.

Further, during many competitive fishing events, the speed of attaching lures is important, as is the security of the attachment means.

Therefore, there exists a need for a fishing lure with a fishing line attachment structure for providing a user with the ability to attach the fishing line relatively easily and quickly to the lure without having to tie a knot and without extraneous intermediate structures.

Also, when fishing in many venues, vegetation, rocks, logs and other debris are present in the water, which also provides cover for the hiding fish, and entices anglers to fish there. However, the vegetation also causes a snag potential during lure retrieval, which poses a hazard for losing lures due to snags, and adding time to unsnag the lure, ultimately resulting in fewer fish catches.

Therefore, there also exists a need for a deflection guard to prevent hooks from snagging vegetation, rocks, and other debris in the water, to enable smooth trouble-free retrieval without delays and lost lures. Yet this weed and debris guard must not inhibit the hook from catching a fish's mouth.

During fishing, it is also common for some fish to swallow the hook too deeply, thereby making removal difficult without harming the fish, and/or taking a long time to remove the hook from deep inside a fish's mouth, gills, or gut.

Therefore, it is also desirable to provide a means on the lure to prevent the fish from swallowing the hook too deeply, such that removal of the hook is difficult or harmful to the fish, both in terms of damage to the fish's mouth and internal organs and reducing the duration of time the fish must be kept out of the water during hook removal, especially if releasing the fish to the water when practicing “catch and release”.

### SUMMARY OF THE INVENTION

The present invention discloses a fishing lure and a fishing line attachment system. The present invention discloses a fishing lure. The fishing lure comprises a head having an aperture. The aperture is configured to receive a fishing line therethrough. The fishing lure further comprises a body structure having a channel to enable passage of the fishing line from the head through a longitudinal axis of the body structure and extend beyond the body structure. The head is configured to lock with the body structure while locking the fishline therein.

The channel extends from a first end portion of the body structure to a second end portion of the body structure. The body structure comprises a body, a neck extending from a body and a jaw portion extending from the neck. The channel, the body and the jaw portion extending from the neck together define the fishing line attachment assembly. The jaw portion comprises a plurality of flared jaws. Each jaw is separated from the adjacent slot to form a flared open configuration. The body comprises a plurality of first ridges over an exterior surface of the body and the neck comprises a plurality of external screw threads. The head comprises a plurality of internal screw threads adapted to screw and lock with the neck comprising external screw threads. The jaw portion is configured to move from the open configuration to a closed configuration when the head screwed over the neck presses the jaws towards the axis of the body, which clenches the fishing line passing therethrough, thereby fastening the fishing line to the fishing lure. The head further comprises a plurality of second ridges over an exterior surface of the head.

The fishing lure further comprises a flexible weed guard mounted over the body to attract fish. The fishing lure further comprises a fishing hook structure integrally configured at the second end portion of the body structure. The fishing hook structure comprises one or more sleeves formed at an area proximal to the second end portion of the body to receive a fishing hook including a bait accessory.

### BRIEF DESCRIPTION OF THE DRAWINGS

FIG. 1 exemplarily illustrates a perspective view of a fishing lure, according to an embodiment of the present invention.

FIG. 2 exemplarily illustrates a perspective view of a body structure of FIG. 1, according to an embodiment of the present invention.

FIG. 3 exemplarily illustrates another perspective view of the body structure of FIG. 1.

FIG. 4 exemplarily illustrates a perspective view of a head of FIG. 1.

FIG. 5 exemplarily illustrates a perspective view of a weed guard of FIG. 1.

FIG. 6 exemplarily illustrates a perspective view of the fishing lure of FIG. 1 with a fishing line, according to an embodiment of the present invention.

FIG. 7 exemplarily illustrates a cross-sectional view of the fishing lure of FIG. 6 with the fishing line.

FIG. 8 exemplarily illustrates a perspective view of the fishing lure of FIG. 1 without the weed guard.

FIG. 9 exemplarily illustrates a cross-sectional view of the fishing lure of FIG. 8 without the weed guard.

FIG. 10 exemplarily illustrates a perspective view of a fishing lure according to an embodiment of the present invention.

FIG. 11 exemplarily illustrates a cross-sectional view of the fishing lure of FIG. 10.

FIG. 12 exemplarily illustrates a perspective view of the fishing lure of FIG. 10 with an additional hook.

FIG. 13 exemplarily illustrates a cross-sectional view of a fishing line attachment structure of the fishing lure of FIG. 10.

FIG. 14 exemplarily illustrates a cross sectional view of the fishing line attachment structure showing the fishing line secured to the fishing lure of FIG. 10.

FIG. 15 exemplarily illustrates a fishing lure incorporated with the fishing line attachment structure of FIG. 10, according to yet another embodiment of the present invention.

FIG. 16 exemplarily illustrates a fishing lure incorporated with the fishing line attachment structure of FIG. 10, according to yet another embodiment of the present invention.

FIG. 17 exemplarily illustrates a fishing lure incorporated with the fishing line attachment structure of FIG. 10, according to yet another embodiment of the present invention.

FIG. 18 exemplarily illustrates a fishing lure incorporated with the fishing line attachment structure of FIG. 10, according to yet another embodiment of the present invention.

FIG. 19 exemplarily illustrates a perspective view of a fishing lure according to yet another embodiment of the present invention.

FIG. 20 exemplarily illustrates a fishing lure incorporated with the fishing line attachment structure of FIG. 19, according to yet another embodiment of the present invention.

### DETAILED DESCRIPTION OF EXAMPLE EMBODIMENTS

Example embodiments of the disclosure now will be described more fully hereinafter with reference to the accompanying drawings, in which example embodiments are shown. The concepts discussed herein may, however, be embodied in many different forms and should not be construed as limited to the example embodiments set forth herein; rather, these embodiments are provided so that this disclosure will be thorough and complete, and will fully convey the scope to those of ordinary skill in the art. Like numbers refer to like elements but not necessarily the same or identical elements throughout.

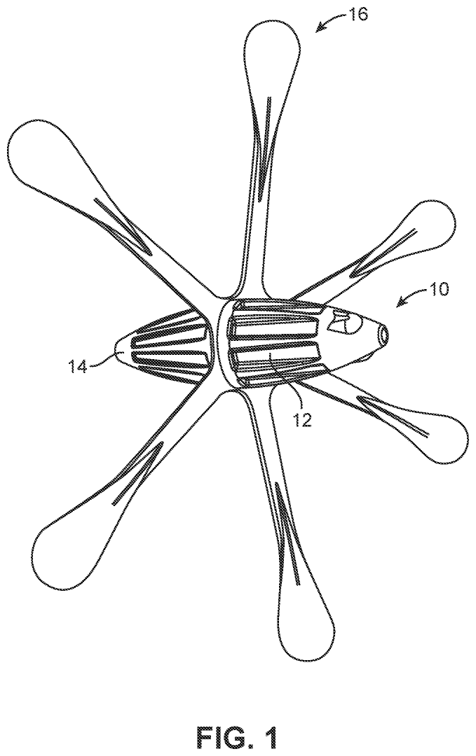

FIG. 1 exemplarily illustrates a perspective view of a fishing lure 10, according to an embodiment of the present invention. The lure 10 comprises a head 12, a body structure 14 and at least one weed guard 16 disposed over the body structure 14. The fishing lure 10 may be made of any suitable material or composition such as wood, plastic, silicone, rubber, metal, cork, carbon fiber, and other suitable materials. The fishing lure shown in the figures is meant to be an example of a fishing accessory and does not limit the fishing lure to that specifically shown fishing accessory. For example, a fishing lure shown could be replaced with a lure or bobber of different sizes, shapes (e.g., spherical, oblong, teardrop, football, or irregular), or materials (balloon, hollow spherical plastic, polystyrene, cork, foam, yarn, neoprene, silicone, or other floating material). Alternatively, the fishing lure could be replaced by a weight. Weights may be, for example, magnets, metal (e.g., lead), sand, or any material that would sink in water. In one or more embodiments, the at least one weed guard 16 is also a bite depth control. In one or more embodiments, the weed guard and bite depth control 16 is made of a plastic or plastic film. Other suitable materials include silicone alloys, magnesium alloys, coated paper products, lead, iron, steel, and brass. Ideally this material will be water resistant.

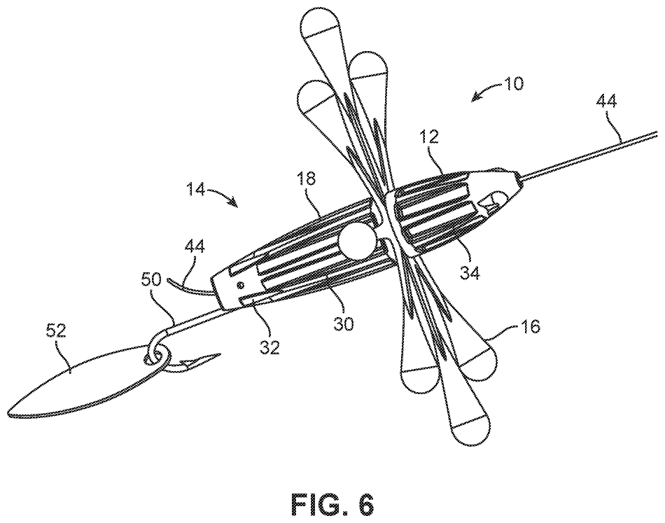

The head 12 defines a female connector, or a first connector, and the body structure 14 defines a male connector, or a second connector. The first connector is configured to lock with the second connector while a fishing line 44 (shown in FIG. 6) passes through a longitudinal axis of the body structure 14. The fishing line 44 may be of any suitable material, including traditional monofilament, braided line, metal cable, or even semi-rigid wire as may be desired.

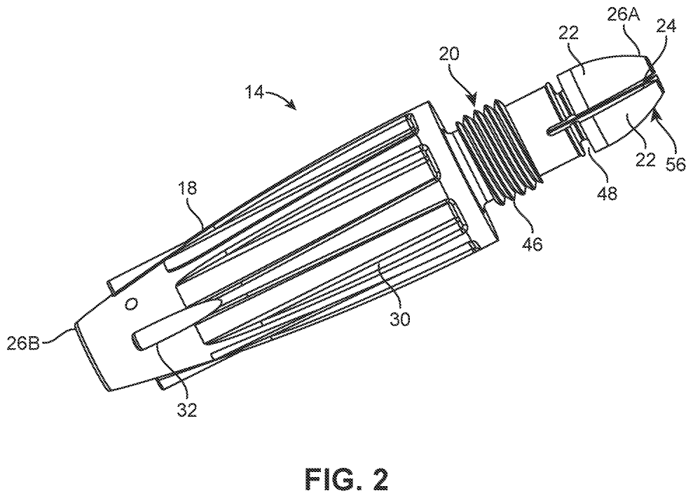

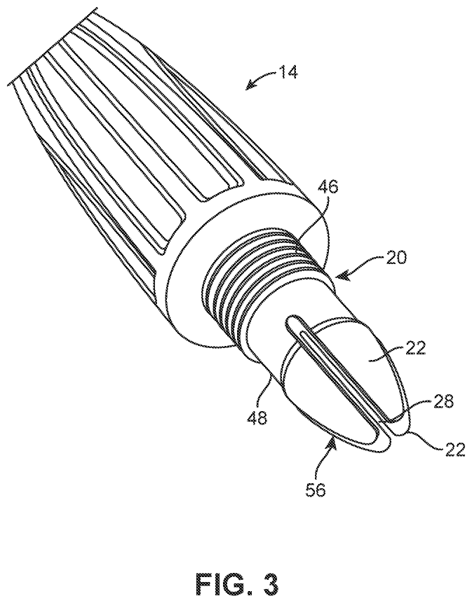

Referring to FIG. 2 and FIG. 3, the body structure 14 comprises a first end portion 26A and a second end portion 26B opposite to the first end portion 26A. A channel 28 extends from the first end portion 26A and terminates at the second end portion 26B. The body structure 14 comprises a body 18, a neck 20 extending from the body 18 and a jaw portion 56 extending from the neck 20. The jaw portion 56 comprises a plurality of flared jaws 22. Each jaw 22 is separated from the adjacent slot 24 to form a flared open configuration. The neck 20 comprises external screw threads 46. The external screw threads 46 is configured on at least a portion of the longitudinal extent of the neck 20. The external threads 46 may extend along the entire longitudinal extent of the neck 20, or along only a portion of the neck 20. The external threads 46 preferably terminate substantially at the lower or bottom end of the neck 46.

The channel 28, the body 18 and the jaw portion 56 extending from the neck 20 together define a fishing line attachment assembly. In one embodiment, the body 18 may be a neutral or negative buoyancy so as to allow the entire assembly to be fully submerged in the water. The body 10 may be smooth or textured and may be plain or contain a design.

The body 18 further comprises a plurality of first ridges 30 over an exterior surface of the body 18. The lure 10 further comprises a fishing hook structure integrally configured at the second end portion 26B of the body structure 14. The fishing hook structure comprises one or more sleeves 32 formed at an area proximal to the second end portion 26B of the body 18.

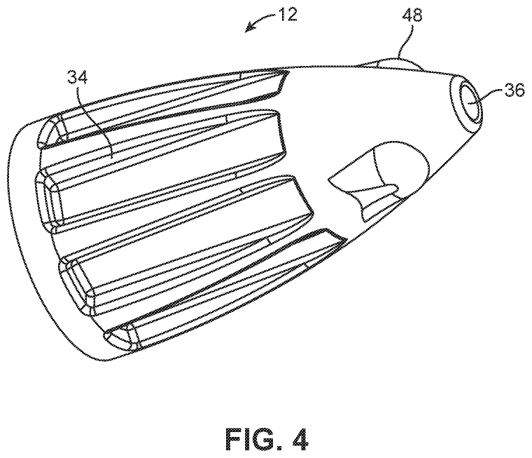

Referring to FIG. 4, the head 12 comprises a plurality of second ridges 34 over an exterior surface of the head 12. The head 12 further comprises an aperture 36 to receive the fishing line 44 therethrough. The head 12 further comprises at least two protrusions 38 configured to mimic a structure of an eye of insects. The fishing lure 10 further comprises a snap-on mechanism 48 at the neck 20. The head 12 is configured to snap-fit over the neck 20 of the lure 10.

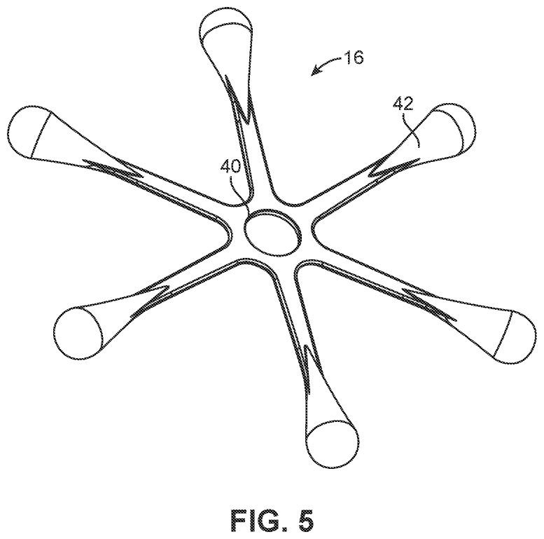

Referring to FIG. 5, the weed guard 16 is a flexible weed guard 16. The weed guard 16 comprises a ring structure 40 and a plurality of legs 42 extends from the ring structure 40. The flexible weed guard 16 mounted over the body 18 to attract fish. The weed guard 16 further helps to prevent tangling with weeds.

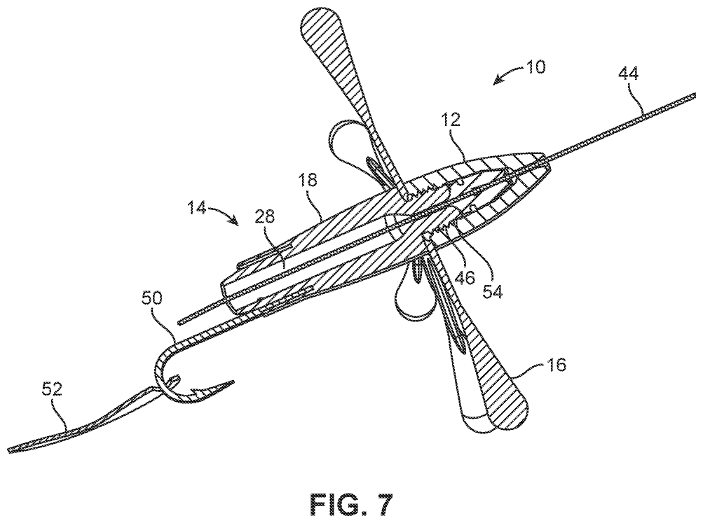

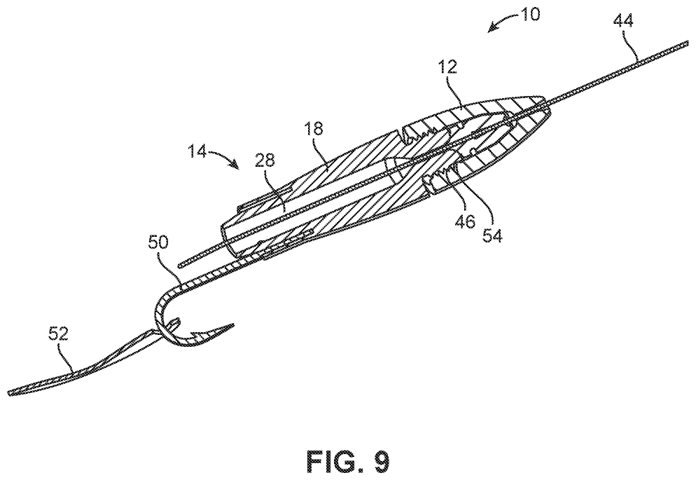

Referring to FIG. 6 to FIG. 9, the fishing line 44 is received through the aperture 36 of the head 12. Then, the fishing line 44 is passed through the channel 28 of the body structure 14 to exit out of the body structure 14 via the second end portion 26B. The head 12 further comprises internal screw threads 54. The internal screw threads 54 are adapted to screw and lock with the neck 20 comprising external screw threads 46.

When the head 12 is screwed over the neck 20, the plurality of jaws 22 moves from the open configuration to the closed configuration. In the open configuration, the plurality of jaws 22 is flared, which keeps the channel 28 open to receive the fishing line 44 passing through the head 12. In the closed configuration, the plurality of jaws 22 are moved towards one another which makes each jaw 22 lie close to the adjacent haw 22. Further, the jaws 22 are pressed towards the axis of the body structure 14 by the head 12 when the head 12 is screwed over the neck 20, which at least partially reduces the diameter of the channel 28. This makes the jaw portion 56 to clinch the fishing line 44 and secure the fishing line 44 to the lure 10. The fishing line 44 may be of any suitable material, including traditional monofilament, braided line, metal cable, or even semi-rigid wire as may be desired.

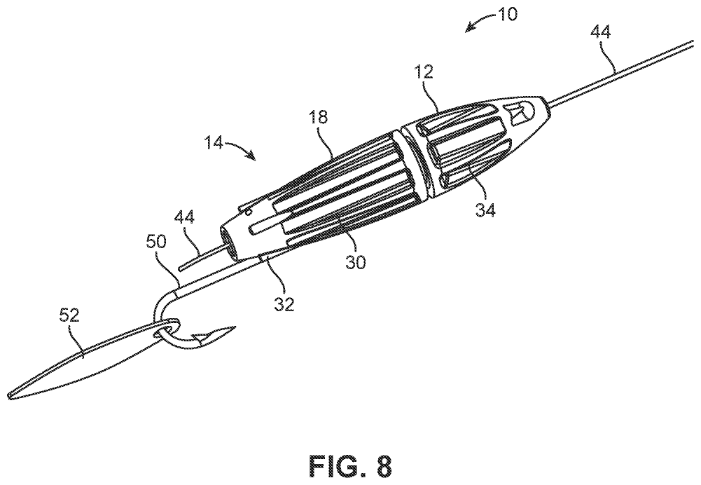

Referring to FIG. 6 and FIG. 8, the fishing hook structure further comprises one or more fishing hooks 50. The hook 50 is received within the sleeve 32. The hook 50 further includes one or more bait accessories 52 to attract the fish. The jaw portion 56 is configured to move from the open configuration to a closed configuration. when the head 12 screwed over the neck 20 presses the jaws 22 towards the axis of the body 18, which clenches the fishing line 44 passing therethrough, thereby fastening the fishing line 44 to the fishing lure 10. The first ridges 30 and the second ridges 34 are configured to provide friction and assist to easily screw the head 12 to the body structure 14.

In one embodiment, the fishing lure 10 is made of polycarbonate plastic. In another embodiment, the fishing lure 10 may be made of any suitable material or composition such as wood, plastic, silicone, rubber, metal, cork, carbon fiber, and other suitable materials. The fishing lure shown in the figures is meant to be an example of a fishing accessory and does not limit the fishing lure to that specifically shown fishing accessory. For example, a fishing lure shown could be replaced with a lure or bobber of different sizes, shapes (e.g. spherical, oblong, teardrop, football, or irregular), or materials (balloon, hollow spherical plastic, polystyrene, cork, foam, yarn, neoprene, silicone, or other floating material). Alternatively, the fishing lure could be replaced by a weight. Weights may be, for example, magnets, metal (e.g. lead), sand, or any material that would sink in water.

In one embodiment, the fishing lure 10 may be configured so that the weed guard 16 can move, rotate, or flex between a relaxed configuration and a tensioned configuration. The weed guard 16 may be configured, or its attachment to the body may be configured, such that the end of the weed guard 16 not connected to the body does not fully enter into the at least partially open volume when the weed guard 16 is in the relaxed configuration. In one embodiment, that end of the weed guard 16 may optionally be able to enter into the open volume when the weed guard 16 is in a tensioned configuration, though it may also be prevented from being able to enter into that volume, such as by limitations in its own flexion, rotation, connection to the head, or by features which prevent such movement, such as by the hook itself. The weed guard 16 may be unitary, may be made of multiple components, may be entirely flexible, or may contain at least one flexible component. The weed guard 16 may be made of a variety of different sheet materials rolled or formed into a cone or may be injection molded as a thin-walled plastic element. In a preferred embodiment, the weed guard 16 is made of a plastic or plastic film. Other suitable materials include silicone alloys, magnesium alloys, coated paper products, lead, iron, steel, and brass. Ideally this material will be water resistant.

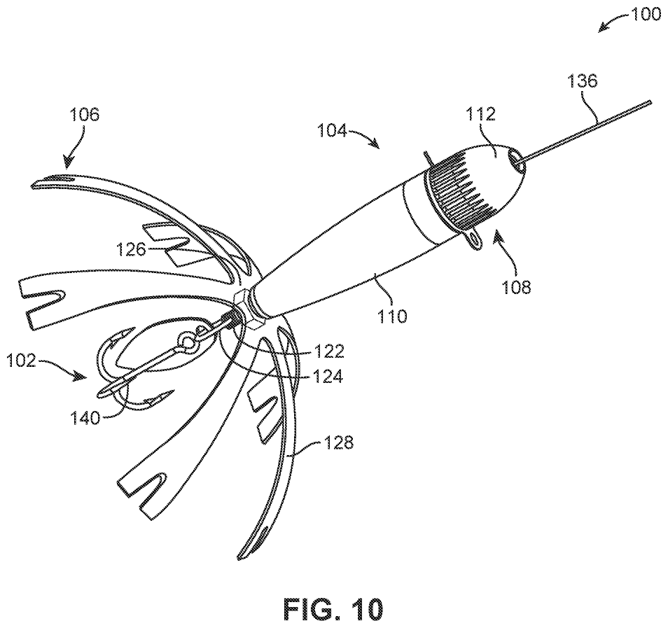

The following part of the description refers to the explanation of FIG. 10 to FIG. 20. The explanation of FIG. 10 to FIG. 20 has some of the terms same as that of FIG. 1 to FIG. 9. While reading the following part of the description, FIG. 10 to FIG. 20 shall be referred. The present invention discloses a fishing lure with a fishing line attachment structure for providing a user with the ability to attach the fishing line relatively easily and quickly to the lure without having to tie a knot and without having to utilize additional or intermediate structures. FIG. 10 exemplarily illustrates a perspective view of a fishing lure 100 according to an embodiment of the present invention. Referring to FIG. 10, the fishing lure 100 (also referred as lure 100) comprises a fishing hook structure 102, a body structure 104 mounted to the fishing hook structure 102 and a weed guard and bite depth control 106 mounted between the fishing hook structure 102 and the body structure 104. It is to be noted that weed guard and bite depth control 106 is an optional element of the fishing lure 100, and other embodiments of the fishing lure 100 without the weed guard and the bite depth control 106 are well within the ambit of the present invention. A fishing line attachment structure 108 configured on the body structure 104. The body structure 104 comprises a body 110, a neck 114 (shown in FIG. 11) extending from the body 110, and a head 112 locked with the neck 114 while clenching the fishing line 136 therebetween.

The fishing lure 100 may be made of any suitable material or composition such as wood, plastic, silicone, rubber, metal, cork, carbon fiber, and other suitable materials. The fishing lure shown in the figures is meant to be an example of a fishing accessory and does not limit the fishing lure to that specifically shown fishing accessory. For example, a fishing lure shown could be replaced with a lure or bobber of different sizes, shapes (e.g., spherical, oblong, teardrop, football, or irregular), or materials (balloon, hollow spherical plastic, polystyrene, cork, foam, yarn, neoprene, silicone, or other floating material). Alternatively, the fishing lure could be replaced by a weight. Weights may be, for example, magnets, metal (e.g., lead), sand, or any material that would sink in water.

The lure 100 further comprises a first eyelet 122 fixedly coupled to a bottom portion of the body 110 for attaching the fishing hook structure 102 including a hook 140. In one embodiment, a ring 124 is connected to the eyelet 122 such that the ring 124 hangs freely from the eyelet 122. The fishing hook structure 102 is attached to the ring 124 such that the fishing hook structure 102 hangs freely from the ring 124. In one embodiment, the fishing hook structure 102 is a treble hook having at least three legs. The lure 100 further comprises the weed guard and bite depth control 106 mounted between the fishing hook structure 102 and the body structure 104. The weed guard and the bite depth control 106 includes a central mount 126 and a plurality of legs or finger like projections 126 extending radially or angularly from the central mount 126. In one embodiment, the body 110 may be a neutral or negative buoyancy so as to allow the entire assembly to be fully submerged in the water.

In one embodiment, the fishing lure may be configured so that the weed guard and bite depth control 106 can move, rotate, or flex between a relaxed configuration and a tensioned configuration. The weed guard and bite depth control 106 may be configured, or its attachment to the body may be configured, such that the end of the weed guard not connected to the body does not fully enter into the at least partially open volume when the weed guard is in the relaxed configuration. In one embodiment, that end of the weed guard and bite depth control 106 may optionally be able to enter into the open volume when the weed guard is in a tensioned configuration, though it may also be prevented from being able to enter into that volume, such as by limitations in its own flexion, rotation, connection to the head, or by features which prevent such movement, such as by the hook itself. The weed guard member may be unitary, may be made of multiple components, may be entirely flexible, or may contain at least one flexible component. The weed guard and bite depth control 106 may be made of a variety of different sheet materials rolled or formed into a cone or may be injection molded as a thin-walled plastic element. In a preferred embodiment, the weed guard and bite depth control 106 is made of a plastic or plastic film. Other suitable materials include silicone alloys, magnesium alloys, coated paper products, lead, iron, steel, and brass. Ideally this material will be water resistant. The body 110 may be smooth or textured and may be plain or contain a design.

Referring to FIG. 11, the neck 114 extends from a top flat base or gripping surface of the body 110. The neck 114 is in cylindrical structure having a top side, a bottom side and a sidewall extending between the top and bottom side. The neck 114 further having a slot or port 116. The port 116 formed on the top side of the neck 114 that extends angularly along a proximal length of the axis of the neck 114 and opens at an exterior side of sidewall or bottom side of the neck. In one embodiment, the port 116 opens at an exterior side of the neck 114. In another embodiment, the port 116 extends angularly along a length of the axis of the neck 114. Further, the bottom portion of the body 110 includes an elongated member 142 to which the central mount 126 is slid and secured in position by fastening a nut 144 over the elongated member 142. Further, the lure includes an addition second eyelet 132.

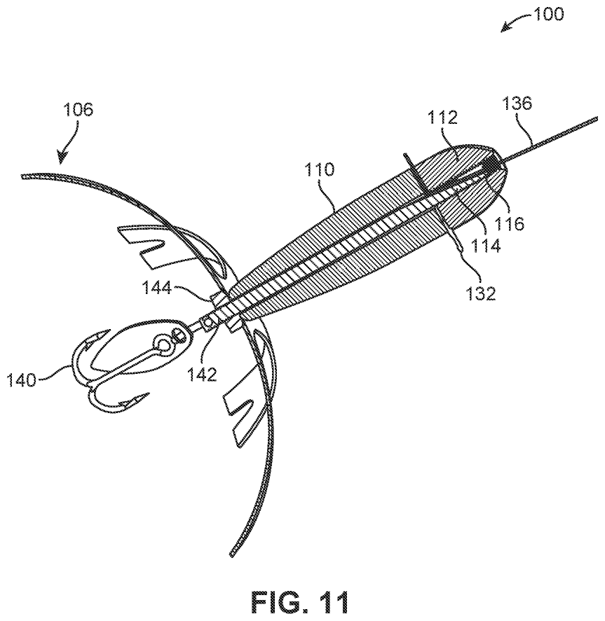

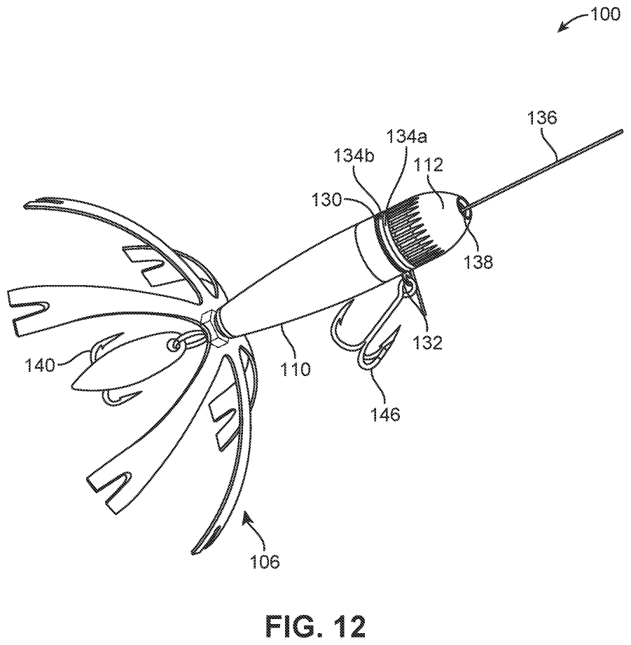

Referring to FIG. 12, the lure 100 further comprises an additional ring member 130 disposed at the top portion of the body 110. The second eyelet 132 extends from the additional ring member 130 for securing additional hook 146. The second eyelet 132 is positioned at an angle from the axis of the body 110 and adapted for fastening a fishing line in a jig format to create an alternative swim behavior. The lure 100 may further comprise at least two additional non-metallic members (134a, 134b) between the gripping surface and the head 112. The gripping surface radiating generally outward at an angle from the axis of the neck 114. The at least two non-metallic members (134a, 134b) include a first non-metallic member 134a and a second non-metallic member 134b. In one embodiment, the members (134a, 134b) may be made of material including, but not limited to, rubber and polymer. In another embodiment, the non-metallic members (134a, 134b) are semi-rigid and softer than the fishing line. The lure 100 includes optional weed guard and bite depth control 106. Further, the head 112 includes an aperture 138 for passage of fishing line 136. The fishing line 136 may be of any suitable material, including traditional monofilament, braided line, metal cable, or even semi-rigid wire as may be desired.

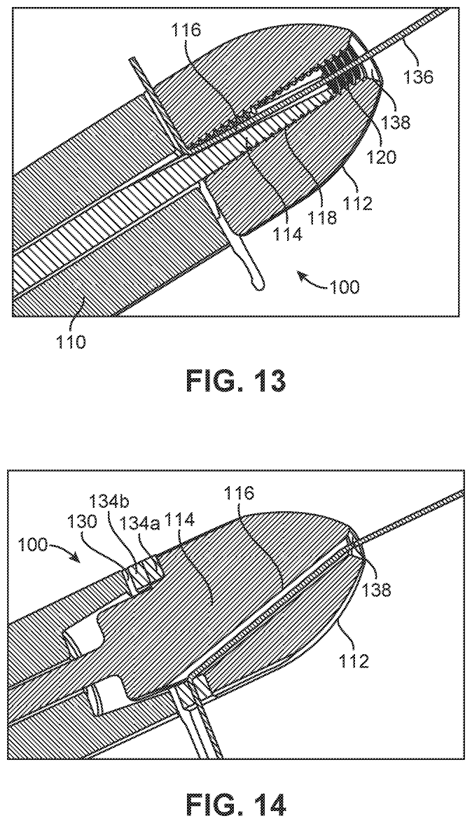

Referring to FIG. 13, the neck 114 includes external circumferential screw threads 118 configured on at least a portion of the longitudinal extent of the neck 114. The external threads 118 may extend along the entire longitudinal extent of the neck 114, or along only a portion of the neck 114. The external threads 118 preferably terminate substantially at the lower or bottom end of the neck 114. The neck 114 further includes the angled port 116. The lure body 110 further comprises the head 112 having internal threads 120 that are adapted to screw and lock with the neck 114. The head 112 further comprises the aperture 138 at a top portion of the head 112. The head 112 allows passage of fishing line 136 from the top portion head 112 to the bottom portion of the head 112. The head 112 defines a first connector and the neck 114 defines a second connector and formed on a top portion of the body 110.

Referring to FIG. 13 and FIG. 14, during installation, the fishing line 136 is passed through the aperture 138 of the head 112, and through the port 116 in the neck 114. The fishing line 136 exits from the side of the neck 114. Further, the fishing line 136 is made to pass through the first washer 134a and pulled out from the body structure 104. A portion the fishing line 136 between the non-metallic members (134a, 134b) of the body 110 while the free end of the line 136 hangs freely outside body structure 104. Then the head 112 is screwed to the body 110 which clenches the fishing line 136 between the base of the body 110, neck 114 and the head 112. Optionally, the fishing line 136 may be wrapped around the neck 144 before screwing the head 112 for additional security in securing the line 136. FIG. 14 exemplarily illustrates a cross sectional view of the fishing line attachment structure 108 showing the fishing line 136 secured to the lure 100. Optionally, the head 112 and neck 114 may lock using a snap fit configuration.

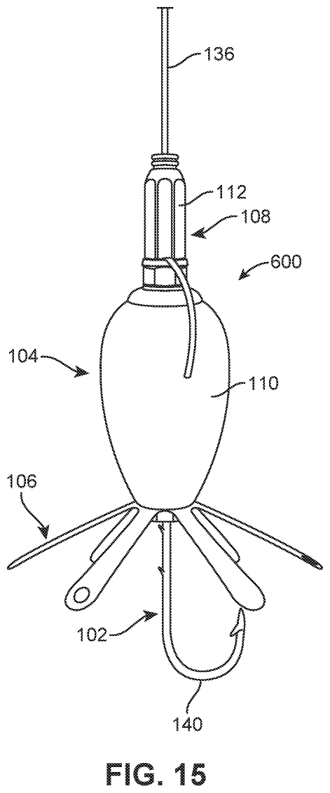

The fishing lure 100 with the fishing line attachment structure 108 of FIG. 10 can be configured in number of embodiments (600, 700, 800, 900) as shown in FIG. 15 to FIG. 18. Embodiments (600, 700, 800, 900) have same components and function as of the embodiment 100 with variation in design and hence same term and same numeral is used describing the components of the embodiments (600, 700, 800, 900). The function and method of operation the embodiments (600, 700, 800, 900) can be understood with reference to the fishing lure 100.

FIG. 15 exemplarily illustrates a fishing lure 600 incorporated with the fishing line attachment structure 108 of FIG. 10, according to yet another embodiment of the present invention. The lure 600 comprises a fishing hook structure 102 including a hook 140, a body structure 104, a weed guard and bite depth control 106 between the fishing hook structure 102 and body structure 104. The body structure 104 includes a body 110, a neck (not shown) having external threads (not shown) and a head 112 having internal threads (not shown). The neck is configured to receive the fishing line 136 and the head 112 is screwed over the neck thereby fastening the fishing line 136 to the fishing lure 600.

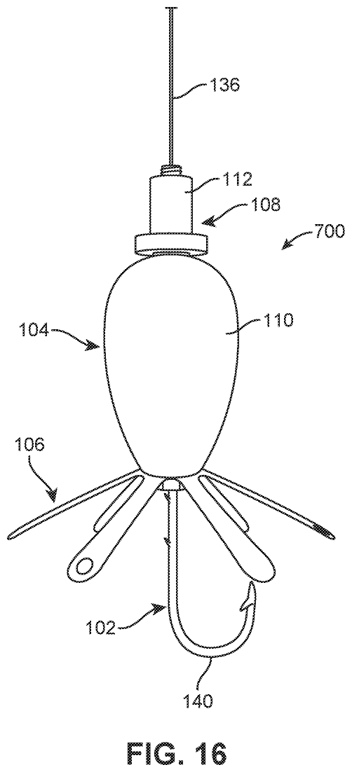

FIG. 16 exemplarily illustrates a fishing lure 700 incorporated with the fishing line attachment structure 108 of FIG. 10, according to yet another embodiment of the present invention. The lure 700 comprises a fishing hook structure 102 including a hook 140, a body structure 104, a weed guard and bite depth control 106 between the fishing hook structure 102 and body structure 104. The body structure 104 includes a body 110, a neck (not shown) having external threads (not shown) and a head 112 having internal threads (not shown). The neck is configured to receive the fishing line 136 and the head 112 is screwed over the neck thereby fastening the fishing line 136 to the fishing lure 700.

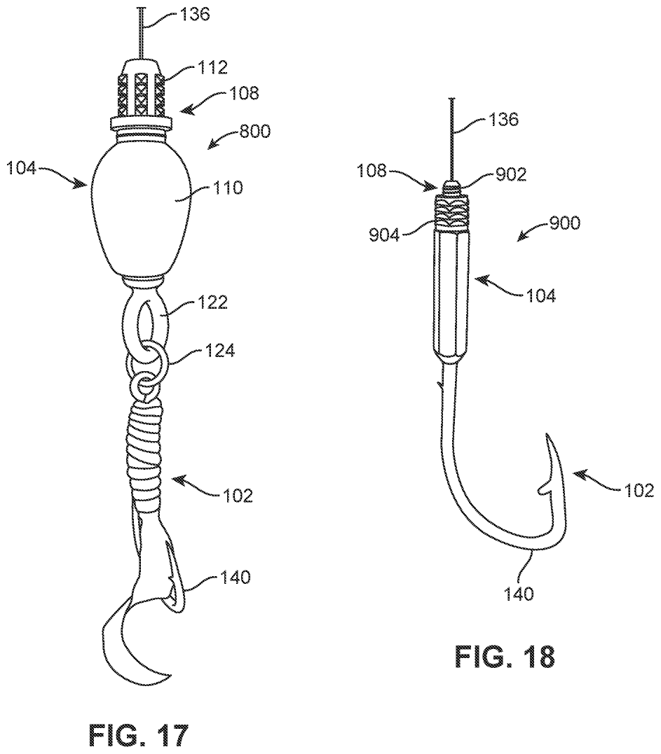

FIG. 17 exemplarily illustrates a fishing lure 800 (also referred as lure) incorporated with the fishing line attachment structure 108 of FIG. 10, according to yet another embodiment of the present invention. The lure 800 comprises a fishing hook structure 102 including a hook 140, a body structure 104 mounted to the fishing hook structure 102. The body structure 104 includes a body 110, a neck (not shown) having external threads (shown) and a head 112 having internal threads (not shown). The neck is configured to receive the fishing line 136 and the head 112 is screwed over the neck thereby fastening the fishing line 136 to the lure 800. The bottom portion of the body 110 includes a first eyelet 122, and a ring 124 connected to the eyelet 122. The hook 140 is coupled to the ring 124 to hang freely.

FIG. 18 exemplarily illustrates a fishing lure 900 incorporated with the fishing line attachment structure 108 of FIG. 10, according to yet another embodiment of the present invention. The lure 900 comprises a body structure 104 and a fishing hook structure 102 mounted to the body structure 104. The fishing hook structure 102 including a hook 140. The body structure 104 includes a cylindrical member 902 having external threads and a lure body member 904 having internal threads (not shown). The lure body member 904 is configured to receive the fishing line 136 and the cylindrical member 902 is screwed over the lure body member 904 thereby fastening the fishing line 136 to the lure 900.

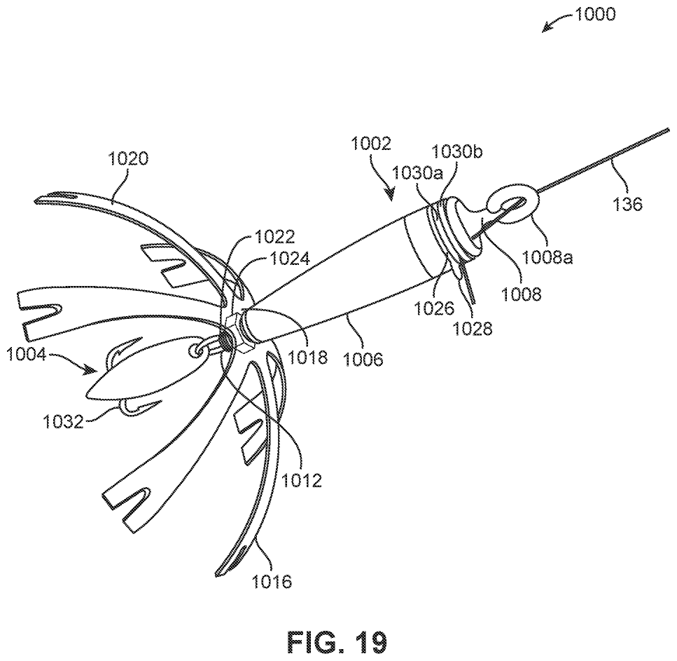

FIG. 19 exemplarily illustrates a perspective view of a fishing lure 1000 according to another embodiment of the present invention. The lure 1000 comprises a body structure 1002 having a body 1006, a shaft (not shown) extending from the body 1006 and a head 1008 to lock with the shaft. The shaft defines the first connector and the head 1008 defines the second connector. The first connector and the second connector are formed on a top portion of the body 1006. The shaft and head 1008 define a fishing line attachment structure.

The lure 1000 comprises a first eyelet 1012 fixedly coupled to a bottom portion of the body 1006 for attaching a fishing hook structure 1004. The fishing hook structure 1004 includes a hook 1032. The fishing hook structure 1004 is attached to the first eyelet 1012 such that the fishing hook structure 1004 hangs freely from the first eyelet 1012. In one embodiment, the fishing hook structure 1004 is a treble hook having at least three legs. The lure 1000 further comprises a weed guard and bite depth control 1016 mounted between the fishing hook structure 1004 and the body structure 1002. The weed guard and bite depth control 1016 includes a central mount 1018 and a plurality of legs or fingerlike projections 1020 extend radially or angularly from the axis of the body 1006. The bottom portion of the body 1006 includes an elongated member 1022 to which the central mount 1018 is slid and secured in position by fastening a nut 1024 over the elongated member 1022. The top portion of the body 1006 further comprises a ring member 1026 disposed over the shaft includes a second eyelet 1028, and the second eyelet 1028 is adapted for fastening an additional second hook structure (not shown). The second eyelet 1028 is positioned at an angle from the axis of the body 1006 and adapted for fastening a fishing line in a jig format to create an alternative swim behavior. The body 1006 further comprises at least two non-metallic members (1030a, 1030b) disposed above the ring member 1026. In one embodiment, the non-metallic members (1030a, 1030b) may be made of material including, but not limited to, rubber and polymer.

Further, a proximal eyelet 1008a is disposed at a top portion of the head 1008. During installation, the fishing line 136 is passed through the proximal eyelet 1008a and loop around the shaft of the body 1006 and between the non-metallic members (1030a, 1030b) before tightening and locking the head 1008 to the shaft. Thereby, the fishing line 136 is clenched between the non-metallic members (1030a, 1030b) on locking the head 1008 to the shaft of the body 1006. In one embodiment, the shaft may include external screw threads and the head 1008 may include internal threads. The internal threads of the head 1008 may screw and lock with the external threads over the shaft.

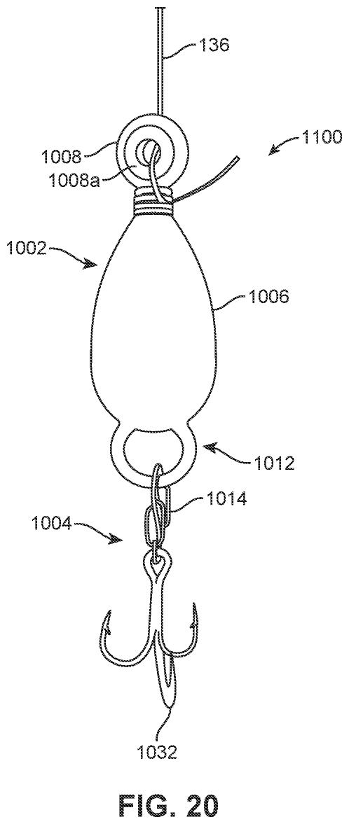

The fishing lure 1000 with the fishing line attachment structure of FIG. 19 can be configured in number of embodiments. One of the embodiments 1100 is shown in FIG. 20. Embodiment 1100 have same components and function as of the embodiment 1000 with variation in design and hence same term and same numeral is used describing the components of the embodiment 1100. The function and method of operation the embodiment 1100 can be understood with reference to the fishing lure 1000.

FIG. 20 exemplarily illustrates a fishing lure 1100 incorporated with the fishing line attachment structure of FIG. 19, according to yet another embodiment of the present invention. The lure 1100 comprises a body structure 1002 having a body 1006, a shaft extending from the body 1006 and a head 1008 to lock with the shaft. The shaft defines the first connector and the head 1008 defines the second connector. The first connector and the second connector are formed on a top portion of the body 1006.

The lure 1100 comprises a first eyelet 1012 fixedly coupled to a bottom portion of the body 1006 for attaching the fishing hook structure 1004. In one embodiment, a ring 1014 is connected to the first eyelet 1012 such that the ring 1014 hangs freely from the first eyelet 1012. The fishing hook structure 1004 is attached to the ring 1014 such that the fishing hook structure 1004 hangs freely from the ring 1014. The fishing hook structure 1004 includes a hook 1032. In one embodiment, the fishing hook structure 1004 is a treble hook having at least three legs.

The fishing line attachment assembly described with respect to FIG. 1 to FIG. 9 could be configured to embodiments described with respect to FIG. 10 to FIG. 20. The fishing line attachment structure 108 could be replaced with the fishing line attachment assembly described with respect to FIG. 1 to FIG. 9. Further, the components of the lure 10 may also be configured to the embodiments described with respect to FIG. 10 to FIG. 20.

Although the features, functions, components, and parts have been described herein in accordance with the teachings of the present disclosure, the scope of coverage of this patent is not limited thereto. On the contrary, this patent covers all embodiments of the teachings of the disclosure that fairly fall within the scope of permissible equivalents.

Many modifications and other implementations of the disclosure set forth herein will be apparent having the benefit of the teachings presented in the foregoing descriptions and the associated drawings. Therefore, it is to be understood that the disclosure is not to be limited to the specific implementations disclosed and that modifications and other implementations are intended to be included within the scope of the appended claims. Although specific terms are employed herein, they are used in a generic and descriptive sense only and not for purposes of limitation.

What is claimed is:

1. A fishing lure, comprising:
a head having an aperture, the aperture is configured to receive a fishing line therethrough;
a body structure having a channel to enable passage of the fishing line from the head through a longitudinal axis of the body structure and extend beyond the body structure, wherein the head is configured to lock with the body structure while locking the fishline therein.

2. The fishing lure of claim 1, wherein the channel extends from a first end portion of the body structure to a second end portion of the body structure.

3. The fishing lure of claim 1, wherein the body structure comprises a body, a neck extending from the body, and a jaw portion extending from the neck.

4. The fishing lure of claim 3, wherein the jaw portion comprises a plurality of flared jaws, each jaw is separated from the adjacent jaw by a slot to form a flared open configuration.

5. The fishing lure of claim 1, further comprises a fishing hook structure integrally configured at the second end portion of the body structure.

6. The fishing lure of claim 5, wherein the fishing hook structure comprises one or more sleeves formed at an area proximal to the second end portion of the body, the sleeve is configured to receive a fishing hook including a bait accessory.

7. The fishing lure of claim 3, further comprises a plurality of first ridges over an exterior surface of the body.

8. The fishing lure of claim 3, further comprises a plurality of second ridges over an exterior surface of the head.

9. The fishing lure of claim 3, wherein the neck comprises a plurality of external screw threads.

10. The fishing lure of claim 3, wherein the head comprises a plurality of internal screw threads adapted to screw and lock with the neck comprising external screw threads.

11. The fishing lure of claim 4, wherein the jaw portion is configured to move from the open configuration to a closed configuration when the head screwed over the neck presses the jaws towards the axis of the body, which clenches the fishing line passing therethrough, thereby fastening the fishing line to the fishing lure.

12. The fishing lure of claim 1, further comprises a flexible weed guard and bite depth control mounted over the body.

13. The fishing lure of claim 3, wherein the head comprises at least two protrusions configured to mimic a structure of an eye of insects.
